(19) United States
(12) Patent Application Publication
(10) Pub. No.: US 2005/0166781 A1
(43) Pub. Date: Aug. 4, 2005

(54) Uses of metamerism in printing

(76) Inventors: Terry-Lee M. Fritz, Boise, ID (US); Dana A. Jacobsen, Boise, ID (US); Micheal Talley, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/772,726

(22) Filed: Feb. 4, 2004

(51) Int. Cl. B42D 15/10; B41M 1/14; B41M 3/14

(52) U.S. Cl. 101/491; 283/72

(57) ABSTRACT

The present invention provides printing methods, printed articles and color printers that take advantage of metamerism.

### BACKGROUND

Metamerism is an effect that is observed when two colored markings appear to match under one light source but not another. An example would be two markings printed with different green inks that appear an indistinguishable green in daylight but appear yellow-green and blue-green under indoor lighting conditions (e.g., under incandescent or fluorescent lighting). Since metamerism reduces the color constancy of printed articles, it is generally viewed as a negative effect in the printing industry and a great deal of effort has been spent in removing or reducing its effect.

### SUMMARY

The present invention provides printing methods, printed articles and color printers that take advantage of metamerism.

In one aspect, a method is provided that allows a user to mark articles for light condition verification purposes. A desired light condition for viewing an article is selected. A pair of metameric markings that have the same color appearance under the selected light condition are then printed on the article. In another aspect, the present invention provides a method of preparing copy-proof paper articles. In another embodiment, a pair of metameric markings are printed on a paper article that have a different color appearance under copier light and the same color appearance under a non-copier light environment. The present invention also encompasses copy-proof paper articles that have been prepared according to the inventive methods.

In a final aspect, the present invention provides color printers that may be used to practice the inventive methods.

### DEFINITIONS

The term “article” as used herein refers to any physical object that can be marked by printing. Without limitation, fabric and paper articles are preferred articles of the invention. The paper articles may be coated or non-coated as is known in the art.

The term “colored marking” as used herein refers to any visible colored mark made upon an article of interest. The marking may be of any shape and size and may be present at any location on the article. Colored images and colored text are encompassed by the term.

The term “ink” as used herein refers to any colored composition that can be used in printing. Typically inks will include one or more colorants such as dyes and/or pigments. It is to be understood that the inventive inks may be liquid or solid. Without limitation, ink-jet inks and laser toners are exemplary liquid and solid inks.

The term “metameric markings” as used herein refers to a pair of colored markings that have the same color appearance under one light condition but not another. Metameric markings have different reflectance curves. Each member of a pair of metameric markings may be produced using a single ink or a mixture of inks. The present invention excludes the use of fluorescent inks.

The term “mixed color” as used herein refers to a colored marking printed with a mixture of inks, e.g., a mixture of process inks.

The term “printing” as used herein refers to any method that may be used to create a marking on an article. Non-limiting printing methods include laser printing, ink-jet printing, offset printing, intaglio printing, relief printing and screen printing.

The term “process ink” as used herein refers to any one of the four standard inks that are commonly used in color printing to reproduce color images. These inks—cyan, magenta, yellow and black—are combined in different proportions to produce a wide range of colors. This standard system is referred to as the CMYK color system in contrast with the RGB (red, green and blue) color system that is used in computer monitors. A colored marking that has been produced with one or more of the process inks is referred to herein as a “process color marking”.

The term “solid color” as used herein refers to a colored marking that was printed with a single ink, e.g., a spot ink.

The term “spot ink” as used herein refers to an ink that does not belong to the “process ink” set. In particular, spot inks are printed as solid colors (i.e., they are not mixed with other spot inks or process inks). A colored marking that has been produced with a spot ink is referred to herein as a “spot color marking”.

### DESCRIPTION OF CERTAIN PREFERRED EMBODIMENTS

The invention will now be described with particular reference to certain preferred embodiments of the invention.

In one aspect, a method is provided that allows a user to mark an article for light condition verification purposes. A desired light condition for viewing the article is selected. A pair of metameric markings that have the same color appearance under the selected light condition are then printed on the article. The user or a third party can then verify that the article is being viewed under the selected light condition by comparing the markings and confirming that they match. It is anticipated that this aspect of the invention will be particularly useful in applications that require a colored article to be compared with another colored article (e.g., a color copy or reprint of that article) under a specific light condition. More generally, the inventive method and articles may be used in any context that requires light condition verification.

An example might involve the specific logo color for a company. Indeed, when trying to determine the exact color for a printed logo, it is imperative to view the printed logo with the same light conditions under which the proof was generated (e.g., fluorescent light). For example, if the logo is being printed using a printing method that has differing output when viewed under natural sunlight or incandescent light versus fluorescent light, it is imperative that the viewer choose the appropriate lighting conditions. This problem can be solved by having the printing house print a pair of metameric markings on the proof (or alternatively on a different article that accompanies the proof) that match under fluorescent light, yet do not match under incandescent light or sunlight. In this way, the person (e.g., a customer) viewing the proof can quickly determine if the lighting conditions are appropriate for the color conditions that the printing house intended when deciding on the logo color.

In general, the metameric markings may be printed as solid colors or as mixed colors. In certain embodiments, the metameric markings are each printed with a member of a pair of metameric inks, e.g., a pair of spot inks or a process ink and a spot ink. In other embodiments, at least one of the first and second markings is printed with a mixture of inks, e.g., a mixture of process inks. In one embodiment spot inks are not used and both markings are printed with process inks. For example, one marking is printed with a single process ink while the metamer is printed with a mixture of process inks. Methods for identifying suitable spot and process inks are described in greater detail in the examples. The markings may be of any size and shape and may be printed at any location on the article of interest. Generally the metameric markings will be printed at relative locations that allow them to be readily compared, e.g., adjacently. In certain embodiments the first marking may be embedded within the second marking.

For certain applications it may prove advantageous to mark an article for more than one light condition. For example, several pairs of metameric markings could be printed on the same article wherein each pair matches under a different light condition. It will be appreciated that a single colored marking may belong to more than one pair of metameric markings. Indeed, the same colored marking may match with a first colored marking under a first light condition and a second colored marking under a second light condition. It is anticipated that such a marked article may find numerous uses. For example, a sheet of paper could be prepared that includes a metameric pair for 2, 3, 4, 5, 10 or more of the most common illuminants. A print house could then send the sheet to a customer and ask him or her to take the sheet to the location where they will be using or displaying the print job. The customer would then identify the pair that matches the best and inform the print house of the result. The print house would then have sufficient information to produce a print job that best suits the customers specific light conditions.

The present invention also encompasses articles that have been marked for light condition verification purposes (i.e., according to the aforementioned method). Preferred articles are fabric and paper articles, including coated and non-coated papers. These articles may or may not include other color markings in addition to the metameric markings. It is to be understood that any additional color markings may be printed on the article before or after the metameric markings. It is further to be understood that any additional color markings may be printed using the same or a different printer as the metameric markings. In preferred embodiments additional markings are printed with the same printer as the metameric markings.

In another aspect, the present invention provides a method of preparing a copy-proof paper article. In one embodiment a pair of metameric markings are printed on the paper article that have the same color appearance under copier light and a different color appearance under non-copier light. The copier “sees” the two markings as having the same color and therefore produces copies in which the two markings are printed with the same combination of copier inks. Originals and copies are readily distinguished by comparing the markings under non-copier light—if they match the paper is a copy; if they do not match the paper is an original. In another embodiment, a pair of metameric markings are printed on a paper article that have a different color appearance under copier light and the same color appearance under a non-copier light environment. The copier “sees” the two markings as having different colors and therefore produces copies in which the two markings are printed with different combinations of copier inks. Originals and copies are readily distinguished by comparing the markings under the non-copier light environment—if they match the paper is an original; if they do not match the paper is a copy. For example, the copying process could turn what looks like a solid area in the original into an area that is non-solid in a copy (e.g., an area that includes embedded text such as COPY, INVALID, VOID, etc.). The present invention also encompasses copy-proof paper articles that have been prepared according to the inventive method. Again, the metameric markings may be printed as solid colors (e.g., using a spot or process ink) or as mixed colors (e.g., using a mixture of process inks).

In a final aspect, the present invention provides color printers that may be used to practice the methods of the present invention. In one embodiment an inventive color printer includes a set of process inks and a spot ink wherein the spot ink forms a metameric pair with one of the process inks or with a mixture of the process inks. In another embodiment a color printer includes a set of process inks and a pair of spot inks that form a metameric pair. In yet another embodiment an inventive color printer lacks spot inks. For example, the color printer includes a collection of process inks, wherein one of the process inks forms a suitable metamer with a mixture of the process inks. The specific color and chemical composition of the spot and process inks will be selected by the user, e.g., without limitation as described above and in the examples.

### EXAMPLES

### Example 1

The following non-limiting example describes a method of identifying suitable inks for marking an article for light-condition verification purposes.

A desired light condition for viewing an article of interest is selected (e.g., incandescent lighting). A collection of cyan inks are selected or prepared using a range of known colorants (i.e., dyes and pigments). The reflectance curves of colored markings that have been printed with the various cyan inks are then measured under the selected light condition. For example, the colored markings are analyzed using a spectrophotometer in a room or area that has been designed to recreate the selected light condition. The reflectance curves of the same colored markings are also measured under a different light environment (e.g., daylight). Known calculation methods are then used to calculate the pairwise degree of metamerism between each of the markings, e.g., as described in DIN 6172 entitled “Special metamerism-index for pairs of samples at change in illuminant”. Pairs of colored markings that exhibit a large degree of metamerism between the two light environments are identified and then visually compared under the selected light condition. Pairs of colored markings that match under the selected light condition are then used to identify pairs of cyan inks that can be used as inks (e.g., as two spot inks or as a spot ink and a process ink) to mark the article of interest.

### Example 2

The following non-limiting example describes a method of identifying suitable process and spot inks for use in preparing a copy-proof paper article of the present invention.

A set of process inks is selected. The process inks are combined in various proportions to produce a matrix of mixed color markings. A set of spot inks (e.g., but not limited to those produced by Pantone Inc. of Carlstadt, N.J.) are also selected and used to produce a set of solid color markings. The matrix of mixed color markings and the set of solid color markings are then viewed in a room or area that has been designed to reproduce copier light. Pairs of markings that match under copier light are identified and then compared under non-copier light, e.g., daylight or incandescent light. Pairs of colored markings that match under copier light but no longer match under non-copier light are highlighted and used to identify those spot inks that form metameric pairs with the process inks. The identified spot and process inks are then used to prepare a copy-proof paper article as described above.

### Example 3

The following non-limiting example describes a method of identifying suitable spot inks for use in preparing a copy-proof paper article of the present invention.

A collection of green inks are selected or prepared using a range of known colorants (i.e., dyes and pigments). Reflectance readings are obtained from each colored marking at a fine grid of wavelengths using a precision spectrophotometer. The readings are then combined with the spectral emission curves of the copier light and incandescent light to compute the reflectance curves of each marking under the two light environments. Known calculation methods are then used to calculate the pairwise degree of metamerism between each of the markings, e.g., as described in DIN 6172 entitled “Special metamerism-index for pairs of samples at change in illuminant”. Pairs of colored markings that exhibit a large degree of metamerism between the two light environments are identified and then visually compared under copier light. Pairs of colored markings that match under copier light are then used to identify pairs of green inks that can be used as spot inks. The identified spot inks are then used to prepare a copy-proof paper article as described above.

### OTHER EMBODIMENTS

Other embodiments of the invention will be apparent to those skilled in the art from a consideration of the specification or practice of the invention disclosed herein. It is intended that the specification and examples be considered as exemplary only, with the true scope of the invention being indicated by the following claims.

1. A method of verifying light conditions comprising:
viewing an article under a given light condition, wherein first and second colored markings have been printed on said article, and wherein said first and second markings are metameric and have the same color appearance under a first light condition;
determining whether said first and second markings have the same color appearance; and thereby
determining whether said article is being viewed under the first light condition.

2. The method of claim 1, wherein said first and second markings were printed with first and second members of a pair of metameric inks, respectively.

3. The method of claim 2, wherein said first and second members of a pair of metameric inks are both spot inks.

4. The method of claim 2, wherein said first and second members of a pair of metameric inks are spot and process inks, respectively.

5. The method of claim 1, wherein at least one of said first and second markings was printed with a mixture of process inks.

6. The method of claim 1, wherein said first and second markings were printed adjacently.

7. The method of claim 1, wherein third and fourth colored markings have been printed on said article, and wherein said third and fourth markings are metameric and have the same color appearance under a second light condition, the method further comprising:
determining whether said third and fourth markings have the same color appearance; and thereby
determining whether said article is being viewed under the second light condition.

8. The method of claim 7, wherein said second and third markings are the same.

9. (canceled)

10. The method of claim 1, wherein said article is a fabric or paper article.

11. (canceled)

12. The method of claim 7, wherein said third and fourth markings were printed with the same printer as said first and second markings.

13. The method of claim 7, wherein said third and fourth markings were printed with a different printer than said first and second markings.

14. A method of verifying light conditions comprising:
viewing an article under a given light condition, wherein a plurality of pairs of metameric markings have been printed on said article, and wherein at least two pairs have the same color appearance under different light conditions;
determining which of the plurality of pairs has the closest color appearance; and thereby
determining the light condition under which said article is being viewed.

15. A method of preparing a copy-proof paper article comprising:
printing first and second colored markings on a paper article, wherein said first and second markings are metameric and have the same color appearance under copier light; or
printing first and second colored markings on a paper article, wherein said first and second markings are metameric and have a different color appearance under copier light.

16. A copy-proof paper article having first and second colored markings printed thereon, wherein said first and second markings are metameric, and wherein:
the first and second markings have the same color appearance under copier light; or
the first and second markings have a different color appearance under copier light.

17-20. (canceled)
